(19) United States
(12) Patent Application Publication
(10) Pub. No.: US 2026/0367406 A1
(43) Pub. Date: Nov. 19, 2026

(54) METHOD FOR PRODUCING OPTICAL ELEMENTS FOR A CUSTOMIZED SPECTACLE LENS FOR AN IMAGE-GENERATING DISPLAY DEVICE WHICH CAN BE POSITIONED ON A USER'S HEAD

(71) Applicant: tooz technologies GmbH, Aalen (DE)

(72) Inventors: Philipp SCHEIDERER, Aalen (DE); René HENSEL, Aalen (DE); Andrea BERNER, Jena (DE)

(21) Appl. No.: 19/482,199

(22) PCT Filed: Apr. 24, 2024
(86) PCT No.: PCT/EP2024/061196

§ 371 Date: Nov. 6, 2025

(30) Foreign Application Priority Data
May 9, 2023 (DE) 102023112083.2

(51) Int. Cl. G02B 27/01

(52) U.S. Cl. CPC G02B 27/0172; G02B 2027/0178

(57) ABSTRACT

A method for producing optical elements for a customized spectacle lens for an image-generating display device, which can be positioned on a user's head, is provided. A plurality of base stacks of a first variant and a plurality of base stacks of a second variant are produced. The base stacks of the same variant in each case have the same optical properties, and base stacks of different variants differ in at least one predetermined optical property. A custom lens is produced for the user based on their visual impairment and based on a selected base stack variant. A base stack of the selected variant and the produced custom lens are provided so as to be able to connect the produced custom lens with the provided base stack to produce the spectacle lens customized for the user.

### PRIORITY

This application claims the priority of German patent application DE 102023112083.2 filed May 9, 2023, which is hereby incorporated herein by reference in its entirety.

### FIELD

The present invention relates to a method for producing optical elements of a customized spectacle lens for an image-generating display device which can be placed onto a user's head. Such a display device can present to the user the generated image in the head-mounted state of the holding device the generated image by means of the customized spectacle lens as a virtual image. Such display devices are often also referred to as HMD devices (head-mounted display devices) or as AR, VR or MR glasses (AR=augmented reality, VR=virtual reality, MR=mixed reality). The spectacle lens often used for this purpose may comprise a waveguide having a first and a second side, a first lens (which may also be referred to as a pull lens) connected to the first side, and a second lens having positive refractive power (which may also be referred to as a push lens) connected to the second side. Since collimated light with a focal plane at infinity is generally used for transporting the generated image in the waveguide, the pull lens serves to pull the focal position of the virtual image into the near range. For observing the surroundings through the spectacle lens, the influence of the pull lens is compensated for by the push lens. Besides adapting the focal plane of the virtual image, the pull lens can be used for individual refraction correction for the user.

### BACKGROUND

The waveguide is a sensitive component and its surfaces need to be kept free of damage and contaminants, since otherwise light required for forming the virtual image may emerge at undesired locations and in so doing not only occurs as a loss of intensity but also may disadvantageously be perceived as extraneous light.

In order to make possible small form factors, the lenses and the waveguide are permanently joined together, e.g. by adhesive bonding or else by a fixing or mounting with e.g. air gaps between the lenses and the waveguide. In this case, all the elements must be aligned as exactly as possible in order to guarantee a satisfactory optical imaging quality.

The manufacture of such a construction comprising the waveguide and the two lenses should therefore take place as far as possible under optimal conditions, such as e.g. in a clean room and using highly accurate processes. Since such manufacture is cost-intensive, not very flexible, and complex, mass production of a standardized product is appropriate, in principle. However, this is at odds with the individual adaptation of the refractive power of the stack comprising the waveguide and the two lenses for compensation of the respective user's ametropia. Furthermore, the user's ametropia may change over the course of time.

### SUMMARY

An object of the invention to provide an improved method for producing optical elements of a customized spectacle lens for a display device which can be placed onto a user's head. Furthermore, the intention is to provide a method for producing an image-generating display device which can be placed onto a user's head, with such a customized spectacle lens.

The method according to certain embodiments provides a modularized approach for the production of the optical elements for customizing the refraction correction of spectacle lenses for an image-generating display device which can be placed onto a user's head. In this regard, the base stacks can be produced in large numbers as standardized products under optimal conditions (such as e.g. in a clean room and using highly accurate processes). The individual adaptation to the respective user or end user is then effected by the selection of the base stack for the user (e.g. on the basis of their ametropia) and by the production of the custom lens for the user on the basis of their ametropia and also on the basis of the selected base stack. The base stacks and the custom lens are optical elements of the customized spectacle lens. A custom lens produced in this way can then be connected to the selected base stack (e.g. to the first lens) in order thus to provide the spectacle lens customized for the user. If this step of connecting the custom lens to the selected base stack is carried out, the method can also be referred to as a method for producing a customized spectacle lens for a display device which can be placed onto a user's head.

In contrast to a spectacle lens for a display device which can be placed onto a user's head with already individually adapted refractive power of the spectacle lens for ametropia correction, the modular approach described here makes possible economically attractive and highly accurate mass production of base stacks of the first and second variants and also of possible further variants (which differ e.g. in their total refractive power and/or in a focal position-caused by the guiding and outcoupling of the light beams-of the imaging of the generated image as a virtual image, said imaging being possible using the display device). In particular, it is possible to produce the plurality of variants with refractive powers in a small number of standardized embodiments with coarse gradation.

The solution according to certain embodiments e.g. also makes possible a highly accurate alignment of the optical elements (in particular of the elements of the base or basic stacks), which is advantageous primarily with the use of high refractive powers. The individual fine adaptation to the user's ametropia is realized in a later process step of the production of the custom element (which is connectable to the provided base stack of the selected variant). The method can, but need not, contain the step of connecting the produced custom lens to the provided base stack of the selected variant.

The production of the custom lens (or of the custom element) is technologically less demanding than the manufacture of the base stack, since the waveguide is already protected by the first lens and the second lens optionally provided. Since the refractive power of the custom element can be of weak design, the alignment of said element is less critical.

The spectacle lens can comprise an entrance portion and a deflection portion spaced apart from the entrance portion, an exit portion in the back side and also a light guiding channel, which guides light beams of the generated image that are incoupled into the spectacle lens via the entrance portion of the spectacle lens in the spectacle lens as far as the deflection portion, by which they are deflected in a direction toward the exit portion and are then outcoupled from the spectacle lens through the exit portion. The guiding in the light guiding channel can be realized by at least one reflection.

The waveguide can comprise the light guiding channel and also the deflection portion. The entrance portion can be formed on the waveguide or on some other part of the customized spectacle lens.

The first lens can have negative refractive power. However, it is also possible for the first lens to have positive refractive power.

The custom lens that is connectable or else connected to the provided base stack of the selected variant can serve as a protective element for the part of the provided base stack to which the custom lens is connected. This can involve the first lens, for example.

The predetermined optical property can comprise the total refractive power of the base stack and/or a focal position (e.g. spaced apart 1 m, 1.5 m or 2 m from the spectacle lens)-caused by the guiding and outcoupling of the light beams (by means of the spectacle lens)-of the presented virtual image (that is to say of the virtual imaging of the generated image during intended use of the customized spectacle lens in the image-generating device which can be placed onto the head). The focal position is generally defined by the pull lens or the lens or lenses (such as e.g. the custom lens) through which the light beams pass on account of the guiding and outcoupling. Furthermore, the predetermined optical property can comprise a coloring, a tinting and/or a polarization effect as a result of a functional layer. Moreover, the predetermined optical property can comprise a spherical refractive power, a cylinder correction and/or a prismatic power. There can also be a difference in respect of the material used (e.g. glass or plastic) and/or the manner of incoupling, guiding and/or the manner of outcoupling of the light beams in the spectacle lens as predetermined optical property.

The custom lens can have one or more of the predetermined optical properties mentioned.

In step A at least one variant of the base stacks can be produced in such a way that the base stack also has a second lens having positive refractive power connected to the second side. The second lens having positive refractive power is an optical element of the customized spectacle lens.

In step A at least one variant of the base stack with the second lens can be produced in such a way that the second lens is equipped with an active optical unit and/or at least one functional layer. An active optical unit can be understood to mean e.g. the embodiment of the second lens as a lens having variably adjustable refractive power or else as a lens comprising an electrochromic layer. By way of example, an anti-reflection layer, a hard layer, a layer having photochromic properties, a tinting layer, a polarization layer and/or some other layer can be used as a functional layer.

Moreover, in step A, in at least one variant of the base stack, the first lens can be produced in such a way that it is equipped with an active optical unit and/or at least one functional layer. An active optical unit can be understood to mean e.g. the embodiment of the first lens as a lens having variably adjustable refractive power or else as a lens comprising an electrochromic layer. By way of example, an anti-reflection layer, a hard layer, a layer having photochromic properties, a tinting layer, a polarization layer and/or some other layer can be used as a functional layer.

In this regard, e.g. the first lens can be embodied as a Fresnel lens with structures directed outward (away from the waveguide). These structures may be unsuitable for everyday use as a spectacle lens since they easily become dirty or are too susceptible to scratches. However, the first lens can be handled under workshop conditions or for a short time without damage. The custom element can then act as a protective layer for the first lens in order to make the spectacle lens suitable for everyday use.

The waveguide can be embodied for example as a highly sensitive component which can be handled only under clean room/laboratory conditions, for example, without being damaged. In this case, the waveguide can be encapsulated and thus protected by the first lens and the second lens, for example. This can be realized e.g. by adhesive bonding, wringing, by connecting in such a way that there is an air gap between the corresponding lens and the waveguide, by molding of the waveguide into the lens material (as a result of which the lenses are also formed at the same time), or by 3D printing of the lenses directly on the waveguide.

In addition, reversible protective layers can also be applied to the base stack in order to enable/improve transport, for example.

The produced custom lens can be releasably connected to the provided base stack (e.g. to the first or second lens of the base stack) of the selected base stack. This makes it possible, if there is a change in the user's refraction, for example, for the existing custom lens to be removed again and replaced by a newly adapted custom lens. The releasable connection, which may also be referred to as a reversible connection, can be realized by a reversible adhesive, for example. The latter can be based on van der Waals interactions, or can be a sublimation adhesive or a thermally varying adhesive. Furthermore, the releasable connection can be realized by a mechanical mount and/or a magnetic mount.

The custom lens can be produced either as an integral custom lens or else as a multipartite custom lens in step B. Preferably, the (integral or multipartite) custom lens is connected to the first lens. During intended use of the display device, the first lens preferably faces toward the user's eye.

In step A the base stacks of at least one variant in step A can be produced in such a way that the first and/or second lens are/is produced as a Fresnel lens.

Furthermore, the base stacks of at least one variant in step A can be produced in such a way that the first side and the second side are each produced as a planar side. In this case, the waveguide is preferably embodied substantially as a plane-parallel plate.

Moreover, the base stacks of at least one variant in step A can be produced in such a way that the first side and/or the second side are/is produced in a curved fashion. This can involve a spherical curvature or an aspherical curvature. However, it is also possible for the corresponding side to be embodied in a curved fashion as a freeform surface.

The waveguide can comprise the entrance portion (e.g. an entrance surface). This portion can be formed on an end face and/or on one of the two sides of the waveguide. However, it is also possible for the entrance portion to be formed on a different element of the spectacle lens.

The deflection portion can comprise a single reflective, refractive and/or diffractive (e.g. holographic) deflection element or a plurality of reflective, refractive or diffractive (e.g. holographic) deflection elements arranged next to one another. The latter can be embodied in a manner fully buried in the waveguide, for example. However, they can e.g. also extend as far as or be formed on a side or boundary surface of the waveguide. With a plurality of deflection elements arranged next to one another, in a Fresnel-like manner, for example, a desired deflection function and optionally an imaging function of the deflection portion can be realized (this can of course also be realized with a single deflection element). The deflection elements can be reflective, refractive and/or diffractive surface segments, which may also be referred to as reflective, refractive and/or diffractive facets. The reflective, refractive and/or diffractive surface segments can each be embodied in a planar fashion. However, it is also possible for the reflective, refractive and/or diffractive surface segments themselves to be embodied in a curved fashion. They can be embodied for example in spherically or aspherically curved fashion or else as a freeform surface. In the same way, the single reflective, refractive and/or diffractive deflection element can be embodied in a planar or curved fashion. The reflectivity of the respective reflective deflection element (or of the single reflective deflection element) can be for example in the range of 1-100% (including the limits of the range) for the respective wavelength or color of the generated image. Consequently, the reflective deflection elements can be embodied in partially reflective or reflective fashion.

Since the outcoupling deflection portion is intended to be as invisible as possible and also to adversely affect as little as possible the light coming from the surroundings to the observer's eye, in general deflection portions are preferred which have a high transmission in see-through view and, in conjunction therewith, a low reflectivity for the light beams of the generated image that are to be outcoupled. Values of 50%, 30%, 10% or 2%, distributed uniformly over the visible length range, are customary for the ratio of reflection to transmission.

The light beams of the generated image are preferably guided as far as the deflection portion by one or more reflections (in particular total internal reflection). The one or more reflections or total internal reflections can be effected e.g. at the first and second sides of the waveguide. If total internal reflections are intended to occur, the required sudden change in refractive index is provided (e.g. by means of an air gap) at the corresponding boundary surface (e.g. at the first and/or second side). Of course, it is also possible to provide a reflective or partially reflective coating for generating reflections.

In the method disclosed herein, the base stacks of at least three different variants in step A can be produced in such a way that the total refractive power of the corresponding base stacks increases by a constant value from variant to variant. This can be realized in particular by virtue of the fact that, in the different variants, the refractive power of the first lens changes from base stack to base stack.

In step B the custom lens can be produced in such a way that it is equipped with an active optical unit and/or at least one functional layer. An active optical unit can be understood to mean e.g. the embodiment of the custom lens as a lens having variably adjustable refractive power or else as a lens comprising an electrochromic layer. By way of example, an anti-reflection layer, a hard layer, a layer having photochromic properties, a tinting layer, a polarization layer and/or some other layer can be used as a functional layer.

Furthermore, in step B the custom lens and also a further custom lens can be produced for the user on the basis of their ametropia and also on the basis of the selected base stack variant, wherein the custom lens is connectable to the first lens and the further custom lens is connectable to the second lens or to the second side.

The method can contain a step of inputting ametropia data describing the user's ametropia, and/or a measurement step for measuring ametropia data describing the user's ametropia.

In particular, all optical elements from which the customized spectacle lens is produced are optical elements of the customized spectacle lens.

Step A can comprise a definition step in which the first and second variants (and possible further variants) of the base stacks are designed or defined.

Of course, both spectacle lenses for an image-generating display device which can be placed onto a user's head can also be produced so as to be customized for the user in the manner described.

Furthermore, a method for producing an image-generating display device which can be placed onto a user's head is provided, wherein a customized spectacle lens is produced from the optical elements that have been or are produced in accordance with the method (including development thereof) and is secured to a holding device, which can be placed onto a user's head and to which is secured an image-generating module, which generates the image, in such a way that the generated image in the head-mounted state of the holding device is formed by means of the customized spectacle lens in such a way that the user can perceive it as a virtual image.

The image-generating module can generate a single-colored image or else a multicolored image.

The display device can comprise a control unit, which controls the image-generating module. In particular, the control unit can control the image-generating module on the basis of supplied image data.

The image-generating module (or the image generator unit) can comprise in particular a planar image generator, such as e.g. an LCD module, an LCOS module, an OLED module, a μLED module or a tilting mirror matrix. The image generator can comprise a plurality of pixels, which can be arranged e.g. in rows and columns. The image generator can be self-luminous or non-self-luminous.

It goes without saying that the features mentioned above and the features yet to be explained hereinafter can be used not only in the specified combinations but also in other combinations or on their own, without departing from the scope of the present invention.

The invention will be explained in even greater detail below on the basis of exemplary embodiments with reference to the accompanying drawings, which likewise disclose features essential to the invention. These exemplary embodiments serve merely for elucidation and should not be construed as restrictive. By way of example, a description of an exemplary embodiment with a multiplicity of elements or components should not be construed as meaning that all of these elements or components are necessary for implementation. Rather, other exemplary embodiments can also contain alternative elements and components, fewer elements or components or additional elements or components. Elements or components of different exemplary embodiments can be combined with one another, unless stated otherwise. Modifications and variations that are described for one of the exemplary embodiments can also be applicable to other exemplary embodiments. In order to avoid repetition, elements that are the same or correspond to one another in different figures are denoted by the same reference signs and are not explained repeatedly.

### BRIEF DESCRIPTION OF THE DRAWINGS

FIG. 1 shows a schematic perspective illustration of one embodiment of the display device;

FIG. 2 shows an enlarged partial sectional view of the first spectacle lens, including a schematic illustration of the image-generating module;

FIGS. 3-5 show illustrations for elucidating the production sequence for producing a customized spectacle lens;

FIG. 6 shows a schematic illustration of a further variant of the spectacle lens according to certain embodiments of the invention;

FIGS. 7-9 show illustrations for elucidating the production sequence for producing a customized spectacle lens in accordance with a further exemplary embodiment;

FIGS. 10-12 show illustrations for elucidating the production sequence for producing a customized spectacle lens in accordance with a further exemplary embodiment;

FIG. 13 shows a schematic sectional view of a further spectacle lens according to certain embodiments of the invention;

FIG. 14 shows a flowchart for elucidating the method according to certain embodiments of the invention for producing optical elements of a customized spectacle lens for an image-generating display device which can be placed onto a user's head; and

FIG. 15 shows a flowchart for elucidating the method according to certain embodiments of the invention for producing an image-generating display device which can be placed onto a user's head.

### DETAILED DESCRIPTION

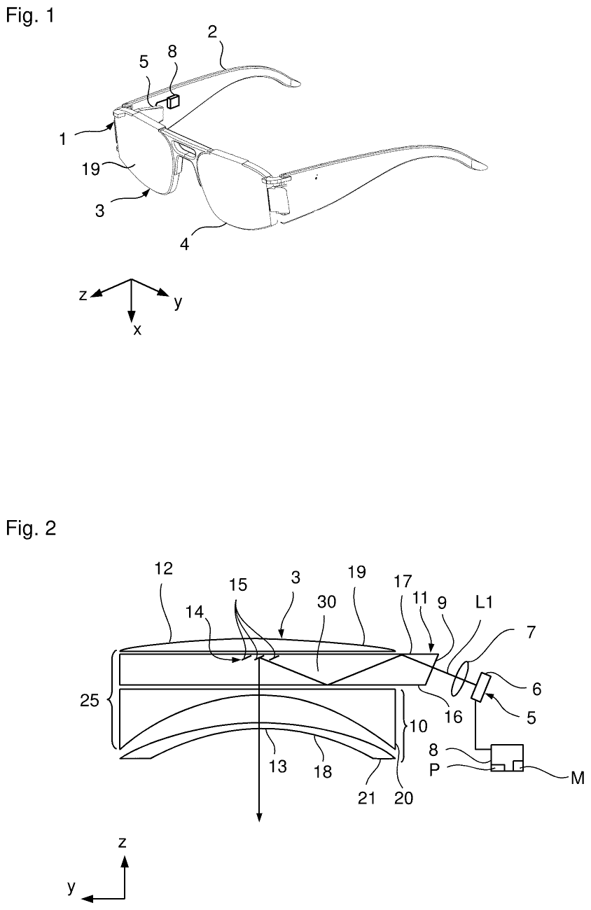

In the case of the embodiment shown in FIG. 1, the display device 1 comprises a holding device 2, which can be placed onto a user's head and can be embodied e.g. in the manner of a conventional spectacle frame, and also a first spectacle lens 3 and a second spectacle lens 4, which are secured to the holding device 2. The holding device 2 with the spectacle lenses 3, 4 can be embodied e.g. as sports goggles, sunglasses and/or spectacles for correcting ametropia, wherein a virtual image can be introduced into the user's field of view via the first spectacle lens 3, which is embodied as a spectacle lens and which may also be referred to as a multifunctional lens, as described below.

For this purpose, the display device 1 comprises an image-generating module 5, which can be arranged in the region of the right-hand spectacle earpiece of the holding device 2, as illustrated schematically in FIG. 1. The image-generating module 5 can comprise an image-generating element 6 for generating an (monochromatic or multicolored) image and an image generator optical unit 7 disposed downstream of the image-generating element 6 (FIG. 2). The image-generating element 6 can be embodied as a planar image-generating element 6, e.g. as an OLED element, an LCD element, an LCOS element, a μLED element or a tilting mirror matrix, each comprising a multiplicity of pixels arranged e.g. in rows and columns. For the light beams emitted by the planar image-generating element 6, a single light beam L1 is depicted schematically in a representative manner.

As can furthermore be gathered from FIG. 2, the image-generating module 5 furthermore comprises a control unit 8 having e.g. a processor P and a memory M for controlling the image-generating module 5. Depending on supplied image data, the control unit 8 controls the image-generating module 5, and in particular the image-generating element 6, in such a way that the desired image is generated and corresponding light beams L1 are thus generated and enter the first spectacle lens 3 via an entrance portion 9 thereof.

The first spectacle lens 3 comprises a first lens system 10 (also referred to hereinafter as a pull lens 10), a waveguide 11 and also a second lens 12 (also referred to hereinafter as a push lens 12). The waveguide 11 is embodied here substantially as a plane-parallel plate having the entrance portion 9 and a deflection portion 14, comprising a plurality of reflective deflection elements 15 spaced apart from one another. The first lens system 10 is connected to a first side 16 of the waveguide 11 and the second lens 12 is connected to a second side 17 of the waveguide 11. During intended use of the display device 1, that side of the first lens system 10 which faces away from the first side 16 faces toward the user's eye and may therefore also be referred to as back side 18 of the first spectacle lens 3. During intended use of the display device 1, that side of the second lens 12 which faces away from the second side 17 faces away from the user and may thus be referred to as front side 19 of the first spectacle lens 3.

As is illustrated schematically in FIG. 2, the generated image (light beams L1) enters the first spectacle lens 3 (or the waveguide 11) via the entrance portion 9 and is guided by reflections at the first and second sides 16, 17 of the waveguide 11 as far as the deflection portion 14 (preferably embodied in a buried fashion), at which it impinges on the reflective deflection elements 15, which then deflect the incoupled image or the light beams L1 in a direction toward the back side 18, such that the incoupled image (light beams L1) exits from the first spectacle lens 3 via an exit portion 13 in the back side 18. The region from the entrance portion 9 as far as the deflection portion 14 in which the light beams L1 are guided by reflections in the waveguide 11 may thus also be referred to as a light guiding channel 30. The reflective deflection elements 15, which may also be referred to as reflective facets 15, can have for example a reflectivity in the range of 1-100%.

The reflections at the first and/or second side 16, 17 can be total internal reflections (if the required sudden change in refractive index is present at the corresponding side, e.g. if there is an air gap between the first side 16 and the first lens system 10 and an air gap between the second side 17 and the second lens 12) or reflections at a reflective or partially reflective coating of the corresponding side 16, 17. The reflective or partially reflective coating can also be formed only on a portion of the corresponding side 16, 17 that is required for guiding light.

Since the light beams L1 are generally incoupled into the waveguide 11 and guided therein in the form of collimated light beams L1, there would be a focal plane for the user at infinity. Therefore, the pull lens 10 is provided in order that the focal position of the generated image lies in the user's near range. The pull lens 10 may also be said to pull the focal position as it were into the user's near range.

In order that the user can observe the surroundings through the first spectacle lens 3, the push lens 12 is provided, which compensates for the change—caused by the pull lens 10—in the focal position of the augmented image from infinity into the near range for see-through view. A user can thus observe the surroundings normally. If e.g. a refraction correction for the user is realized in the pull lens 10, this effect is maintained for the augmented image and the see-through view image.

The waveguide 11 is an optically sensitive component and its surfaces (first and second sides 16, 17) need to be kept free of damage and contaminants. Otherwise, light of the light beams L1 which shape the virtual or augmented image would emerge at unusual places and would not only be present as a loss of intensity but also be perceived as extraneous light.

In order to be able to ensure the desired optical quality for the first spectacle lens 3, the production of the first spectacle lens 3 should take place under optimal conditions, such as for example in a clean room and using highly accurate processes. However, this is at odds with the requirement of being able to carry out an individual ametropia adaptation for the respective user.

Therefore, in the case of the first spectacle lens 3, the first lens system 10 is embodied in a bipartite fashion. It comprises a base element 20 or a base lens 20, which is connected to the first side 16 of the waveguide 11, and a custom element 21 or a custom lens 21, which is connected to the base lens 20. The base lens 20 may also be referred to as first lens 20.

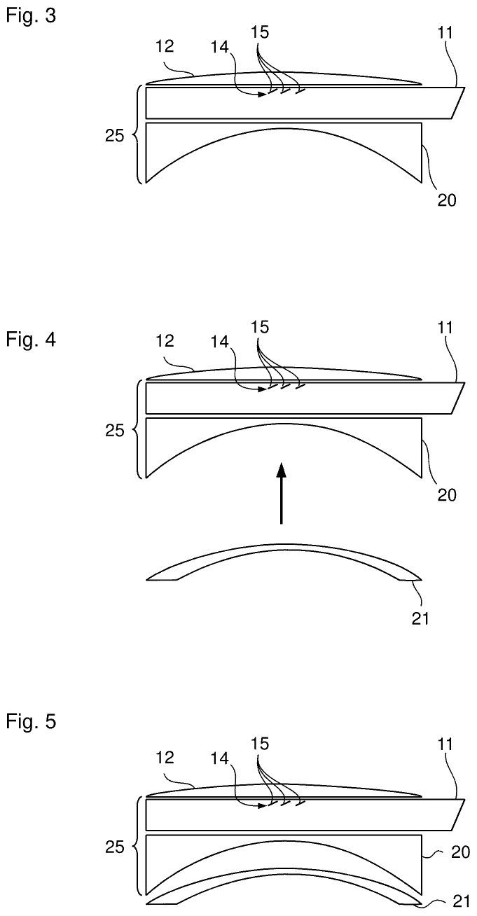

On account of the bipartite embodiment of the first lens system 10, it is thus possible to provide a base stack 25 for the first spectacle lens 3, said base stack comprising the waveguide 11, the second lens 12 connected thereto, and the base element 20 connected thereto. This base stack 25 can be manufactured in high numbers under the desired optimal conditions. For individual adaptation to a user, a custom lens 21 adapted to the user can then be connected to the base element 20 of the base stack 25 in a customization step. It is thus advantageously possible for the custom lens 21 to be designed in a manner dependent on the total refractive power of the base stack 25 and the individual ametropia of the user, produced and then connected to the base element 25, with the result that the desired customized first spectacle lens 3 is produced. This sequence is illustrated schematically in FIGS. 3-5. In this regard, at least two variants of a base stack can be defined (also referred to hereinafter as definition step), wherein the at least two variants differ in at least one predetermined optical property, such as e.g. the total refractive power of the base stacks, e.g. in constant steps.

In a subsequent step, it is then possible to produce a multiplicity of base stacks of each variant (also referred to hereinafter as step A).

A base stack variant is then selected and a base stack 25 of the selected base stack variant is shown in FIG. 3.

In the subsequent customization, a custom lens 21 is produced for the user on the basis of their ametropia and on the basis of the selected base stack 25 (also referred to hereinafter as step B) and the produced custom lens 21 and also the base stack 25 of the selected variant are provided, such that these two optical elements 21 and 25 can be connected to one another in order to be able to produce the desired customized spectacle lens 3 (also referred to hereinafter as step C).

For the purpose of producing the customized spectacle lens 3, the custom lens 21 is then connected to the base element 20 of the base stack 25 (FIG. 4), thus yielding the customized first spectacle lens 3 (FIG. 5). The step of connecting the custom lens 21 to the base element 20 of the base stack 25 can, but need not, be part of step C.

This procedure can result in an individual correction for the user which for example can have a spherical power, a cylindrical and/or prismatic power and thus allows the individual compensation of the user's ametropia. The use of cylindrical power necessitates aligning the axis of the custom lens 21 appropriately with respect to the user. This is easily possible in the course of the integration of the custom lens 21, since the custom lens 21 can be individually contoured and then integrated in a correct orientation.

This procedure furthermore affords the advantage of protection of the optically used surfaces (first and second sides 16, 17) of the waveguide 11 in conjunction with the base stacks 25 produced. The customization for the user is thus carried out with a protected waveguide 11 within the base stack 25.

Since different base stack variants are provided, it is possible to select a base stack 25 of the base stack variant for the individual ametropia correction for a user which requires e.g. only an easily manufactured custom lens 21 and/or a custom lens 21 with weak optical power. Since ametropia is typically more likely to deteriorate than improve over the course of time, the selection of the appropriate base stack 25 (and thus of the appropriate base element 20) can involve rounding down the refractive power, i.e. choosing the weaker base element 20, if the refraction lies between two provided values.

The custom element 21 is preferably installed in a reversible manner, such that e.g. if there is a change in the user's refraction, the custom element 21 can be released from the base element 20 and removed and, instead, a new adapted custom element 21 can be newly connected to the base element 20. The connection of the custom element 21 to the base element 20 can thus be reversible.

Such reversibility can be realized by means of reversible adhesives, for example. The latter can be based on van der Waals interactions, or can be sublimation adhesives or thermally varying adhesives. Mechanical or magnetic mounts are a further possibility.

In some applications, it is advantageous for the base element 20 and/or the other elements of the base stack 25 to be protected against external influences by one or more capping layers. By way of example, the base element 20 can be manufactured from one or more materials that need to be protected against environmental influences, and/or can be provided with a surface structure that needs to be protected against scratches and contaminations, and/or can contain sensitive functional layers. In these cases, the base element 20 and/or the other elements of the base stack 25 can then be provided with a protective layer. Furthermore, e.g. the base element 20 can serve as a protective layer or protective element for the waveguide 11, which may be very sensitive upon mechanical contact, for example.

Since additional optically effective surfaces are integrated into the first spectacle lens 3 by virtue of the custom element 21, the materials and geometries can be chosen in such a way that the aberrations of the entire first spectacle lens 3 are minimized.

The custom lens 21 can be equipped with an active optical unit or other functional layers, for example. The latter can be used for customization in regard to the user's refraction.

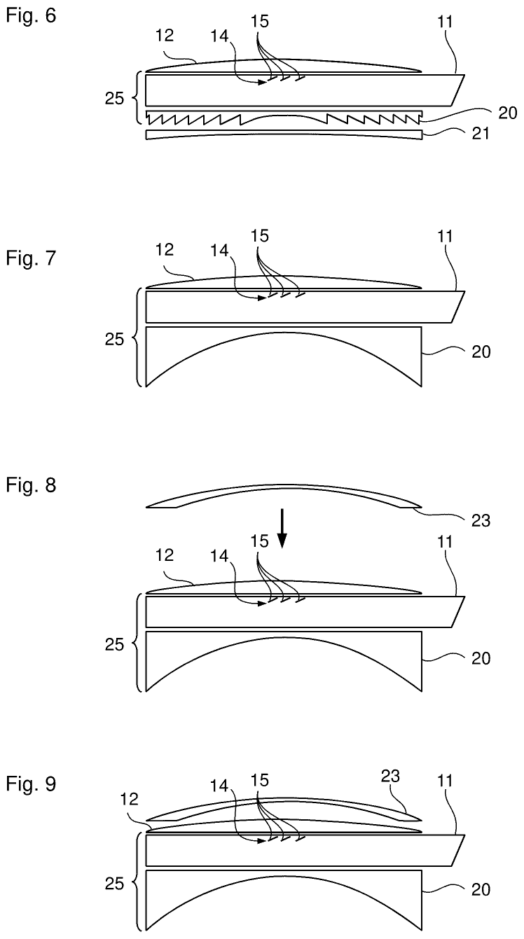

The base element 20 can be provided with a fresnelized surface, as is illustrated schematically in FIG. 6. Optical elements having continuous surfaces have a large form factor primarily in conjunction with high refractive powers. This is particularly disturbing in the case of the base stacks 25 or the first spectacle lens 3 described, since the waveguide 10 and the pull lens 20 in comparison with vision correction spectacles lead to higher weight and thickness at the first spectacle lens 3. Therefore, it is advantageous to use Fresnel lenses as pull lens 10 and in particular as base element 20. The Fresnel lens can then be produced in a few embodiments (e.g. refractive power in 1 diopter steps). Moreover, the custom element 21 protects the surface structure of the base element 20 embodied as a Fresnel lens.

The arrangement/order of the base stack 25 and of the custom element 21 can be as desired. For example, as an alternative to the exemplary embodiments described previously, it is possible to implement a customization with a custom element 23 on the side of the push lens 12, as is shown in FIGS. 7-9. In this case, the push lens 12 is embodied in a bipartite fashion. This is advantageous e.g. for vision correction in the case of a hyperopic or presbyopic user.

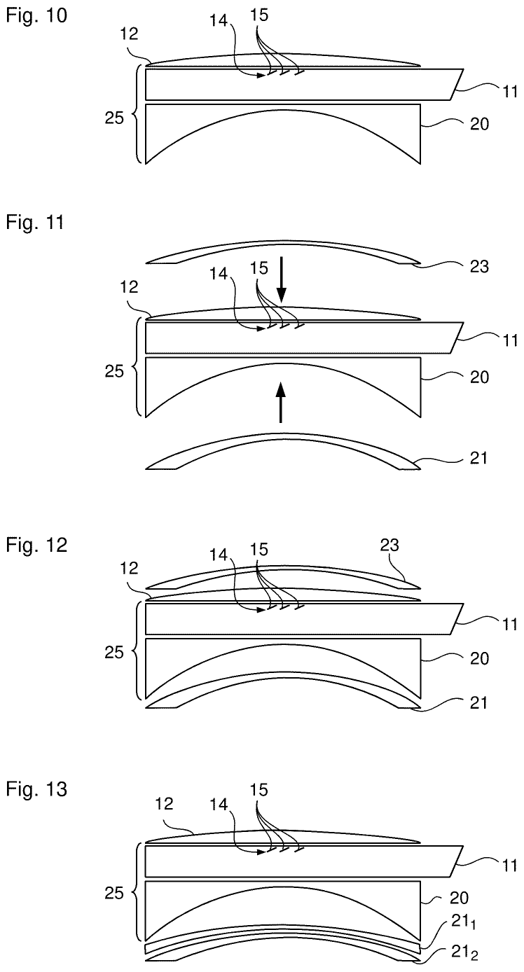

It is furthermore possible, for example, for both the pull lens 10 and the push lens 12 each to be embodied in a bipartite fashion with a corresponding custom element 21, 23, as is shown in FIGS. 10-12.

Neither of the respective custom elements 21, 23 is limited to a single optical element, such as has been described previously. In this regard, the respective custom element 21, 23 can also be formed from a plurality of optical elements (e.g. two, three, four, five or more optical elements). FIG. 13 schematically shows a first spectacle lens 3, wherein the custom element 21 is formed from two partial elements 211, 212.

The optical effect of the base element 20 is not restricted to the examples described above, but rather can also encompass other effects, such as e.g. electrochromism, active optics, etc.

The integration of the lenses 12, 20 and of the waveguide 11 in the basic stack 25 can be effected e.g. not only by joining together by adhesive bonding but also by molding or by a mechanical mounting or some other mounting. It is also possible here in each case to realize an air gap or a material having a low refractive index (preferably having a lower refractive index than the refractive index of the material of the waveguide 11) between the elements 12 and 11 and also between the elements 20 and 11.

In the exemplary embodiments described, for example, the base element 20 can be used as coarse compensation of ametropia in the base stack 25. If the first spectacle lens 3 is intended to be used to present the virtual image with a focal position at 2 m, the design can be manifested as follows, for example: The push lens 12 is embodied with a refractive power of +0.5 dpt (dpt=diopter). The base element 20 is embodied in nine gradations with the refractive powers −5.5 dpt, −4.5 dpt, −3.5 dpt, −2.5 dpt, −1.5 dpt, −0.5 dpt, +0.5 dpt, +1.5 dpt, +2.5 dpt. Base stacks 25 are mass produced under optimal conditions with each of the nine gradations of the base element 20.

A subsequent customization step necessitates compensating for the ametropia of each respective user or end user. If the end user has e.g. a refraction of −3.5 dpt (sph=spherical), 1 dpt (cyl=cylindrical), it is possible to select a base stack 25 with −3.5 dpt, which in combination with the push lens 12 has a total refractive power of −3 dpt (sph). The custom element 21 is manufactured with a refractive power of −0.5 dpt (sph) and +1 dpt (cyl) and is integrated into the base stack 25 in the orientation adapted to the end user (axis of the cylinder). The integration of the custom element 21 can take place in a non-optimal industrial manufacturing environment, for example on an optician's premises, on a retailer's premises or at the user's or end user's home.

The custom element 21 can be integrated in a reversible manner. Consequently, the custom element 21 can be exchanged if there is a change in the end user's refraction.

The base element 20 with its nine gradations can also be embodied in each case as a fresnelized base element 20. Such Fresnel lenses 20 advantageously have a smaller thickness than continuous lenses. If the Fresnel structure is oriented away from the waveguide 11, it is advantageous to protect the surface against soiling and damage. This is realized by applying the custom element 21. The gap between the custom element 21 and the base element 20 can be filled with air or a filling material. The custom element 21 can be integrated in a reversible manner. Consequently, the custom element 21 can be exchanged if there is a change in the end user's refraction.

Furthermore, the base element 20 can be chosen in such a way that the base stack 25 without custom lens 21 has an optical power of 0 dpt.

In the case of an emmetropic end user, the base element 20 is embodied with the same refractive power (the sign being opposite, however) as that of the push lens 12. In this way, the resulting refractive power for looking through the base stack 25 is 0 dpt and the focal position of the virtual image (or augmented image) is set by the refractive power of the base element. If the end user develops ametropia over the course of time, this can be compensated for by applying a custom element 21.

In all the exemplary embodiments described, the following functionalities can also be used in an advantageous manner.

The custom lens 21 additionally acts as a capping layer in order to protect the underlying layers against environmental influences and to mechanically stabilize the layer sequence of the base stack 25.

The custom element 21 can be integrated in a reversible manner. Consequently, the custom element 21 can be exchanged if there is a change in the end user's refraction.

Functional layers can also be integrated in the base stack 25, which functional layers are optionally protected by the custom element 21 and can optionally be exchanged by reversible integration of the custom element 21.

The display device 1 can also be embodied in such a way that the virtual image is presented via the left spectacle lens 4. In this case, the left spectacle lens 4 is produced as a customized multifunctional lens 4 in the manner described above. Furthermore, in this case, the image-generating module 5 is preferably arranged in the region of the left spectacle earpiece. Furthermore, it is possible for the display device 1 to image the virtual image both via the left spectacle lens 3 and via the right spectacle lens 4 (e.g. in order to generate a three-dimensional image impression). In this case, both spectacle lenses 3, 4 can be produced as customized multifunctional lenses 3, 4 in the manner described above. Preferably, a separate image-generating module 5 is then arranged for each spectacle lens 3, 4 (preferably in the left and right spectacle earpieces).

The deflection portion 14 can have the effect purely of beam deflection. Preferably, it can additionally provide an imaging effect.

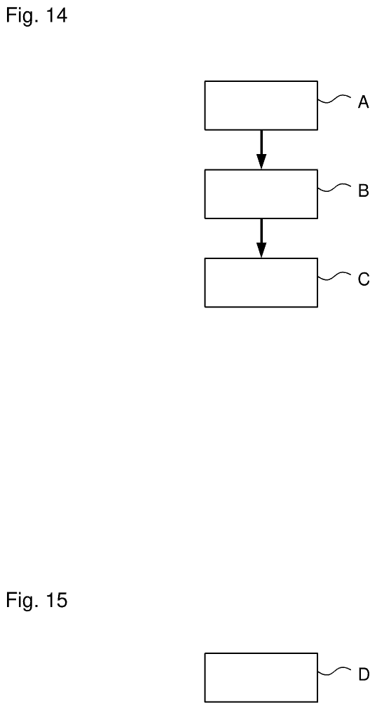

The method for producing optical elements of a customized spectacle lens 3, 4 for an image-generating display device 1 which can be placed onto a user's head can thus comprise the following steps, as is shown schematically in FIG. 14.

Step A: producing a plurality of base stacks 25 of a first variant and a plurality of base stacks of a second variant, wherein the base stacks 25 of all variants each comprise a waveguide 11 having a first side 16 and a second side 17 and a first lens 20 connected to the first side 16. Furthermore, the base stacks 25 of the same variant are characterized by the fact that they each have the same optical properties, although base stacks of different variants differ in at least one predetermined optical property. Of course, it is also possible to produce more than two different variants of base stacks 25.

The predetermined optical property can comprise the total refractive power of the base stack 25 and/or a focal position (e.g. spaced apart 1 m, 1.5 m or 2 m from the spectacle lens)-caused by the guiding and outcoupling of the light beams-of the presented virtual image (during intended use of the customized spectacle lens in the image-generating device which can be placed onto the head).

Step B: producing a custom lens 21 for the user on the basis of their ametropia and also on the basis of a selected base stack variant.

Step C: providing a base stack of the selected variant and the produced custom lens 21. Thus, the spectacle lens 3 customized for the user can then be produced. Step C can, but need not, comprise the sub-step of connecting the produced custom lens 21 to the provided base stack 25, as is shown e.g. in FIGS. 5, 9 and 13. If the sub-step of connecting the produced custom lens 21 to the provided base stack 25 is carried out, the method can also be referred to as a method for producing a customized spectacle lens 3, 4 for an image-generating display device 1 which can be placed onto a user's head.

The method for producing optical elements of a customized spectacle lens 3, 4 for an image-generating display device 1 which can be placed onto a user's head or the method for producing a customized spectacle lens 3, 4 for an image-generating display device 1 which can be placed onto a user's head is thus concluded.

If there is a desire to produce an image-generating display device 1 which can be placed onto a user's head with a customized spectacle lens 3, it is possible firstly to produce a customized spectacle lens 3, 4 by means of steps A-C and then, in a step D (FIG. 14), to secure the customized spectacle lens 3, 4 thus produced to a holding device 2, which can be placed onto a user's head and to which is secured an image-generating module 5, which generates the image, in such a way that the generated image in the head-mounted state of the holding device 2 is imaged by means of the customized spectacle lens in such a way that the user can perceive it as a virtual image.

While the invention has been described in connection with what is presently considered to be the most practical and preferred embodiments, it will be apparent to those of ordinary skill in the art that the invention is not to be limited to the disclosed embodiments. It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products. Moreover, features or aspects of various example embodiments may be mixed and matched (even if such combination is not explicitly described herein) without departing from the scope of the invention.

1-18. (canceled)

19. A method for producing optical elements of a customized spectacle lens for an image-generating display device which can be placed onto a user's head, wherein the spectacle lens has a front side and a back side and also guides light beams of the generated image that are incoupled into the spectacle lens in the spectacle lens and outcouples them via its back side, the method comprising:
A) producing a plurality of base stacks of a first variant and a plurality of base stacks of a second variant, wherein the base stacks of the first and second variants each comprise a waveguide having a first side and a second side and a first lens connected to the first side, the base stacks of the first variant each having identical optical properties, the base stacks of the second variant each having identical optical properties, and the base stacks of the first variant differing in at least one predetermined optical property from the base stacks of the second variant,
B) producing a custom lens for the user based upon an ametropia of the user and also based upon a selected base stack variant, and
C) providing a base stack of the selected variant and the produced custom lens to connect the produced custom lens to the provided base stack to produce the spectacle lens customized for the user.

20. The method of claim 19, wherein, in step B, the selected base stack variant is selected based upon the ametropia of the user.

21. The method of claim 19, wherein the predetermined optical property comprises the total refractive power of the base stack and/or a focal position, which is caused by the guiding and outcoupling of the light beams, of the imaging of the generated image as a virtual image, said imaging enabled via the image-generating display device.

22. The method of claim 19, wherein, in step A, a plurality of base stacks of at least one further variant are produced.

23. The method of claim 19, wherein, in step A, at least one of the first and second variant of the base stacks is produced such that the base stack also includes a second lens having positive refractive power connected to the second side.

24. The method of claim 23, wherein, in step A, the at least one of the first and second variant of the base stack with the second lens is produced such that the second lens is equipped with an active optical unit and/or at least one functional layer.

25. The method of claim 19, wherein, in step A, in at least one of the first and second variant of the base stacks, the first lens is produced such that it is equipped with an active optical unit and/or at least one functional layer.

26. The method of claim 19, wherein the custom lens in step B is produced such that the custom lens is connectable to the first lens.

27. The method of claim 19, wherein the custom lens in step B is produced in such that the custom lens is releasably connectable to the selected base stack.

28. The method of claim 19, wherein the custom lens in step B is produced as an integral custom lens.

29. The method of claim 19, wherein the custom lens in step B is produced as a multipartite custom lens.

30. The method of claim 19, wherein the base stacks of at least one of the first and second variants of the base stack in step A are produced such that the first and/or second lens are/is produced as a Fresnel lens.

31. The method of claim 19, wherein at least one of the first and second variants of the base stack in step A are produced such that the first side and the second side are each produced as a planar side.

32. The method of claim 19, wherein the base stacks of at least one of the first and second variants of the base stack in step A are produced such that the first side and/or the second side are/is produced in a curved fashion.

33. The method of claim 19, wherein the base stacks of at least three different variants in step A are produced such that a total refractive power of corresponding base stacks increases by a constant value from variant to variant.

34. The method of claim 19, wherein the custom lens in step B is produced such that the custom lens is equipped with an active optical unit and/or at least one functional layer.

35. The method of claim 19, wherein, in step B, the custom lens and also a further custom lens are produced for the user based upon the ametropia of the user and also based on a selected base stack variant, wherein the custom lens is connectable to the first lens and the further custom lens is connectable to the second lens or to the second side.

36. A method for producing an image-generating display device which can be placed onto a user's head, the method comprising:
producing a customized spectacle lens from the optical elements produced according to the method of claim 19; and
securing the customized spectacle lens to a holding device, which can be placed onto a user's head and to which is secured an image-generating module, which generates the image, in such a way that the generated image in the head-mounted state of the holding device is imaged via the customized spectacle lens such that the user can perceive the generated image as a virtual image.
